(19) United States
(12) Patent Application Publication
(10) Pub. No.: US 2017/0159840 A1
(43) Pub. Date: Jun. 8, 2017

(54) Coupling Device for a Valve Arrangement

(71) Applicant: BorgWarner Inc., Auburn Hills, MN (US)

(72) Inventors: Petr D. Malik, Rochester Hills, MI (US); Robert D. Keefover, Lake Orion, MI (US); Murray F. Busato, Clinton Township, MI (US)

(21) Appl. No.: 15/439,376

(22) Filed: Feb. 22, 2017

(51) Int. Cl. F16K 31/04; F16K 27/02

(52) U.S. Cl. CPC F16K 31/043; F16K 27/029

(57) ABSTRACT

A coupling device for a valve arrangement includes a valve. The valve includes a valve shaft. The valve includes a first cavity, having a first shaped cross-section, extending into a portion of the valve shaft and having a first coefficient of thermal expansion (CTE). The valve includes a valve plate, having a second CTE. The valve plate includes a second cavity, having a second shaped cross-section. The valve includes a coupling device, having a third CTE, a first end having a first shaped cross-section, for engagement with the first cavity, and a second end having a second shaped cross-section for engagement with the second cavity. At a first operating temperature the coupling device will have a clearance within at least one of the first or second cavities. At a second operating temperature, the coupling device does not have clearance within the first or second cavities.

### BACKGROUND OF THE INVENTION

1. Field of the Invention

The present invention relates to a coupling device for a valve arrangement.

2. Description of Related Art

A variety of valves may be used for controlling functions of an internal combustion engine. These functions may include intake air control and exhaust gas flow control. The types of valves that may be used may include; flap style valves, poppet valves, or throttle valves.

FIG. 1 shows an isometric view of typical throttle valve 1 for controlling exhaust flow. FIG. 2 shows an isometric view of throttle valve 1 with some components removed. FIG. 3 shows an offset cross section view A-A taken from FIG. 1 of throttle valve 1. Referring to FIGS. 1, 2 and 3, the throttle valve 1 may include a valve housing 2 having a bore 3 for receiving and delivering exhaust gas. A valve shaft 4 may pass through the bore 3 and may be supported by the valve housing 2 for rotation about its central longitudinal axis 5. Bushings 6 may also be used to provide a bearing surface for the rotation of valve shaft 4. A valve plate 7 may be fastened to the shaft 4 by fasteners 8. The fasteners may be screws, rivets, pins, welding or other suitable fastening means. Valve plate 7 is located within bore 3 and may rotate with the valve shaft 4 to control the opening and closing of the throttle valve 1 and the flow of exhaust gas through the throttle valve 1.

An actuator 9 may be used to rotate and position the valve shaft 4. The actuator 9 may be one of a variety that may include pneumatic, hydraulic or electric. The actuator 9 may include actuator housings 11 and 12 that may contain an electric motor and associated gear drive system. Actuator housing 12 may be attached to actuator housing 11 and a cover 13 that may enclose the actuator housing 12. The cover 13 may include electrical connections to provide power and control for the actuator 9. Actuator housing 11 may also be attached to the valve housing 2 by a valve adapter housing 10 which is also attached to valve housing 2. The actuator 9 may have a rotatable output shaft 14 that may extend from the actuator housing 11. The rotatable output shaft 14 may be operably connected to a pinion gear 15. Pinion gear 15 may engage a drive gear 16 that may be operably connected to the valve shaft 4. Drive gear 16 may be formed as portion of the valve shaft 4 or it may a separate component operably connected to valve shaft 4.

Referring to FIG. 2, it may be noted that as actuator 9 rotates the output shaft 14 in a first direction 17, the rotational force of the output shaft 14 is translated to the pinion gear 15, drive gear 16, and valve shaft 4, and may cause the valve shaft 4 to rotate in a first direction 18 that may cause the valve plate 7 to move in a valve closing direction 19. It may also be noted that as the output shaft 14 is rotated in a second direction 20, the rotational force of the output shaft 14 is translated to the pinion gear 15, drive gear 16, valve and shaft 4, and may cause the valve shaft 4 to rotate in a second direction 21 that may cause the valve plate 7 to move in a valve opening direction 22. It may also be desirable to limit the rotation of the valve plate 7 to avoid over rotation in the valve opening direction 22. Referring to FIG. 4, stop features 23 and 24 may be added to the valve adapter housing 10 and drive gear 16 to limit the rotation of the valve plate and avoid over rotation.

FIG. 5A shows a partial assembly view, of throttle valve 1. FIG. 5B shows section view B-B from FIG. 5A. For reference, and for the purpose of illustration, the bore 3 has been represented as dashed lines in FIG. 5B. The valve shaft 4 may be offset relative to the valve plate 7 (i.e., the valve shaft may be spaced from a center of the valve plate 7) in order to prevent the valve plate 7 from inadvertently being opened from the valve closed position, by (for example) exhaust gas pressure. When drive gear 16 rotates the valve shaft 4 in the first direction 18 and the valve plate 7 is rotating in the valve closing direction 19, the rotation of valve plate 7 may be stopped when valve plate 7 contacts the bore 3. When the valve plate 7 is rotated into forced contact with bore 3, a torsional force may be translated via drive gear 16 to valve shaft 4. Since the valve plate 7 and the valve shaft 4 can no longer rotate, the torsional force will apply a generally shearing force in directions 25 and 26 to the fasteners 8, as shown in FIG. 5B. A torsional force may also be applied during other operating condition. For example, when the valve plate 7 is positioned between the valve closed and opening positions, exhaust gas pressure may act against the torsional force translated to the valve shaft 4 and may result in a shearing force on the fasteners 8. Other conditions such as exhaust gas pulsations, physical shock, vibration, rapid acceleration and deceleration of valve plate 7 may also impose a shearing force on fasteners 8.

Selection of the material used for fasteners 8 is therefore important to ensure adequate strength to avoid shearing the connection of fasteners 8 and valve plate 7 which may cause a loss of control of the valve plate 7. Providing adequate strength to the connection is advantageous for preventing this undesirable condition. It may be desirable to use high strength materials such as nickel-chromium steels for the valve shaft 4, valve plate 7, and fastener 8. The strength of these materials may be adequate at lower temperatures, however, even these materials may have reduced strength at higher temperatures. It is an objective of the present invention to provide additional strength to the connection of the valve shaft 4 and valve plate 7 and at the elevated temperatures.

### SUMMARY OF THE INVENTION AND ADVANTAGES

The subject invention provides for a coupling device for a valve arrangement comprising a valve. The valve comprises a valve housing including a bore for receiving and delivering a fluid and a rotatable valve shaft for receiving and translating a rotatable force. The valve shaft is supported in the valve housing and has a central longitudinal axis. The valve further comprises a first cavity, having a first shaped cross-section, extending into a portion of the valve shaft along the central longitudinal axis and having a first coefficient of thermal expansion (CTE).

The valve further comprises a valve plate, having a second CTE, located within the bore of the valve housing. The valve plate is rotatable, between a valve open and valve closed position, by the rotatable force translated by the valve shaft. The valve plate further comprises an opening extending into the valve plate for receiving the valve shaft. The opening also shares the central longitudinal axis of the valve shaft. The valve plate further comprises a second cavity, having a second shaped cross-section, extending from the opening further into the valve plate.

The valve further comprises a coupling device, having a third CTE, a first end having a first shaped cross-section, for engagement with the first cavity of the valve shaft, and a second end having a second shaped cross-section for engagement with the second cavity of the valve plate.

At a first operating temperature the coupling device will have a clearance within at least one of the first or second cavities. At a second operating temperature, wherein the valve shaft is being rotated by a rotatable force, at least one of the first CTE of the valve shaft, the second CTE of the valve plate, or the third CTE of the coupling device, will result in a dimensional change and the coupling device does not have clearance within the first or second cavities. The coupling device translates the rotatable force to the valve plate, and bears a shearing force and the first operating temperature is lower than the second operating temperature.

The subject invention also provides for a coupling device for a valve arrangement comprising a valve. The valve comprises a valve housing including a bore for receiving and delivering a fluid and a rotatable valve shaft for receiving and translating a rotatable force. The valve shaft is supported in the valve housing and has a central longitudinal axis and an end, having a first shaped cross-section, extending from the end of the valve shaft along the central longitudinal axis and having a first coefficient of thermal expansion (CTE).

The valve further comprises a valve plate, having a second CTE, located within the bore of the valve housing. The valve plate is rotatable, between a valve open and valve closed position, by the rotatable force translated by the valve shaft. The valve plate further comprises an opening extending into the valve plate for receiving the valve shaft, the opening also sharing the central longitudinal axis of the valve shaft and a cavity, having a second shaped cross-section, extending from the opening further into the valve plate. The end of the valve shaft, having the first shaped cross-section, is inserted into the opening of the valve plate and the first shaped cross-section, of the end of the valve shaft, engages the second shaped cross-section of the cavity of the valve plate.

At a first operating temperature there is a clearance within the cavity of the valve plate and the first shaped cross-section on the end of the valve shaft. At a second operating temperature, and wherein the valve shaft is being rotated by a rotatable force, at least one of the first CTE of the valve shaft or the second CTE of the valve plate will result in a dimensional change. There is no clearance within the cavity, of the valve plate, and the first shaped cross-section, on the end of the valve shaft. The end of the valve shaft with the first shaped cross-section. The first operating temperature is lower than the second operating temperature.

As such, the subject invention provides the advantage of improved strength at a higher temperature and while allowing for assembly at a lower temperature.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a prior art throttle valve for controlling exhaust flow.

FIG. 2 is a perspective view of the prior art throttle valve with some components removed.

FIG. 3 is a cross-sectional view of the prior art throttle valve taken along A-A in FIG. 1.

FIG. 4 is a perspective view of the prior art throttle valve with a valve plate in a valve open position.

FIG. 5A is an elevational view of the prior art throttle valve, comprising a drive gear, a valve shaft, fasteners, and a valve plate.

FIG. 5B is a cross-sectional view of the prior art throttle valve taken along B-B in FIG. 5A.

FIG. 6A is an exploded view of a valve comprising a drive gear, a first valve shaft, a second valve shaft, a coupling device, fasteners, and valve plate.

FIG. 6B is a perspective view of the coupling device shown in FIG. 6A.

FIG. 6C is an elevational view of a portion of FIG. 6A taken in the direction of arrow Z.

FIG. 6D is an elevational view of a portion of FIG. 6A taken in the direction of arrow Y.

FIG. 7A is a perspective view of the valve shown in FIG. 6A.

FIG. 7B is a cross-sectional view of the valve taken along C-C in FIG. 7A.

FIG. 7C is a portion of the cross-sectional view shown in FIG. 7B.

FIG. 8A is an exploded view of a valve comprising a drive gear, a first valve shaft having a coupling device, a second valve shaft, a coupling device, fasteners, and valve plate.

FIG. 8B is a perspective view of the coupling device shown in FIG. 8A.

FIG. 8C is an elevational view of a portion of FIG. 8A taken in the direction of arrow V.

FIG. 8D is an elevational view of a portion of FIG. 8A taken in the direction of arrow U.

FIG. 9A is a perspective view of the valve shown in FIG. 8A.

FIG. 9B is a cross-sectional view of the valve taken along D-D in FIG. 8A.

FIG. 9C is a portion of the cross-sectional view shown in FIG. 9B.

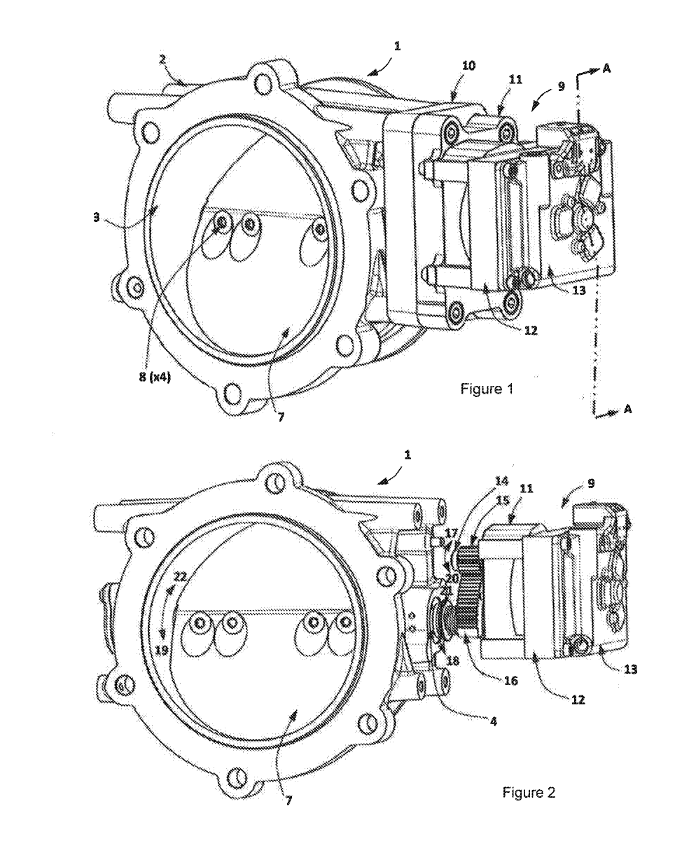

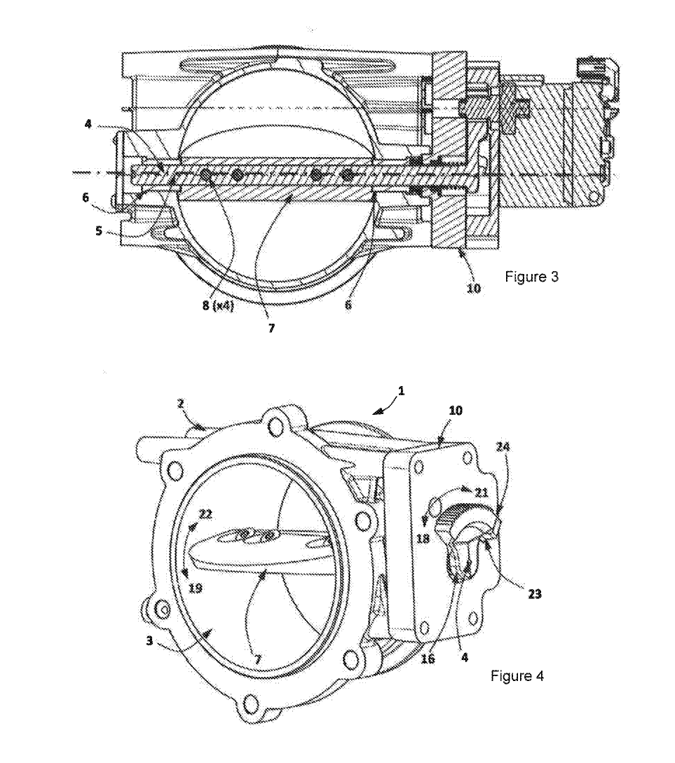

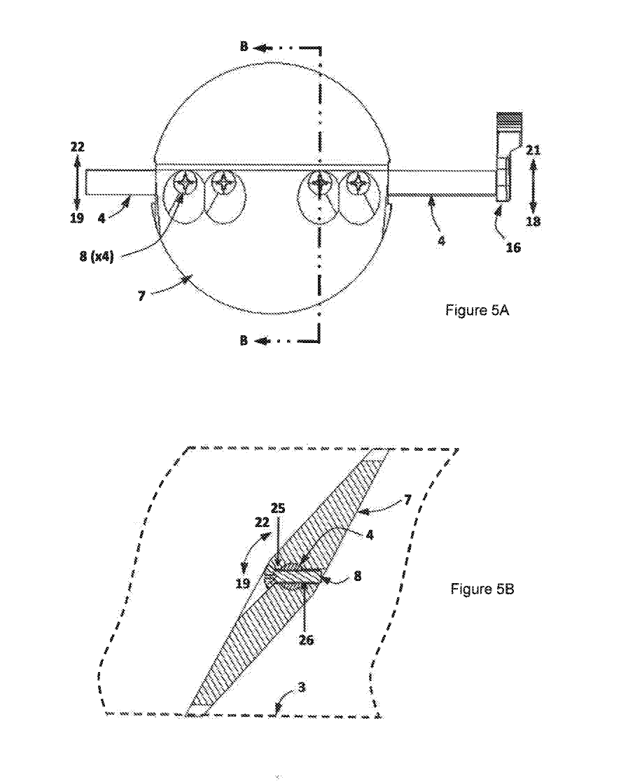

### DETAILED DESCRIPTION OF THE INVENTION

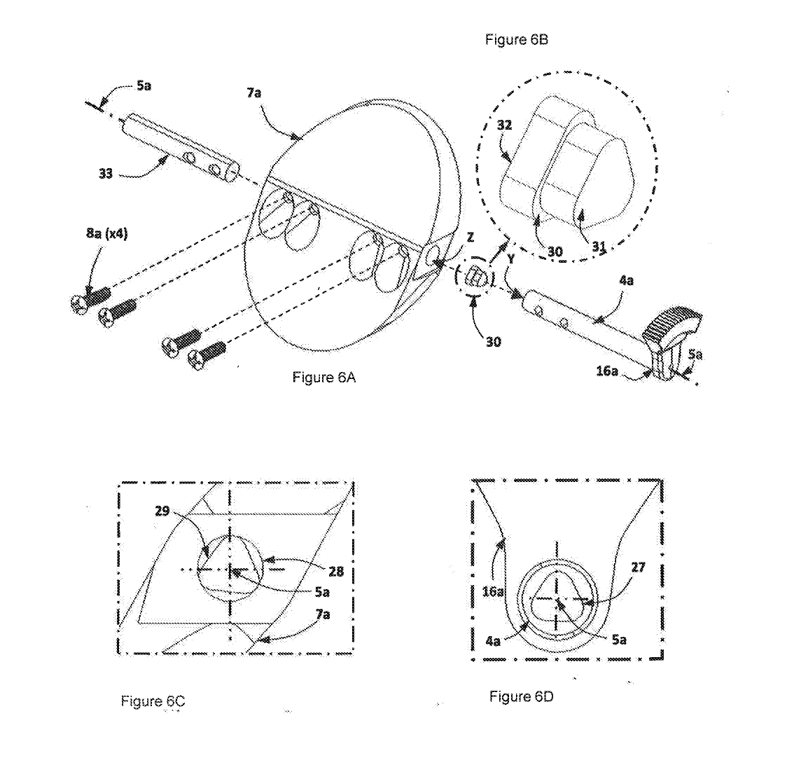

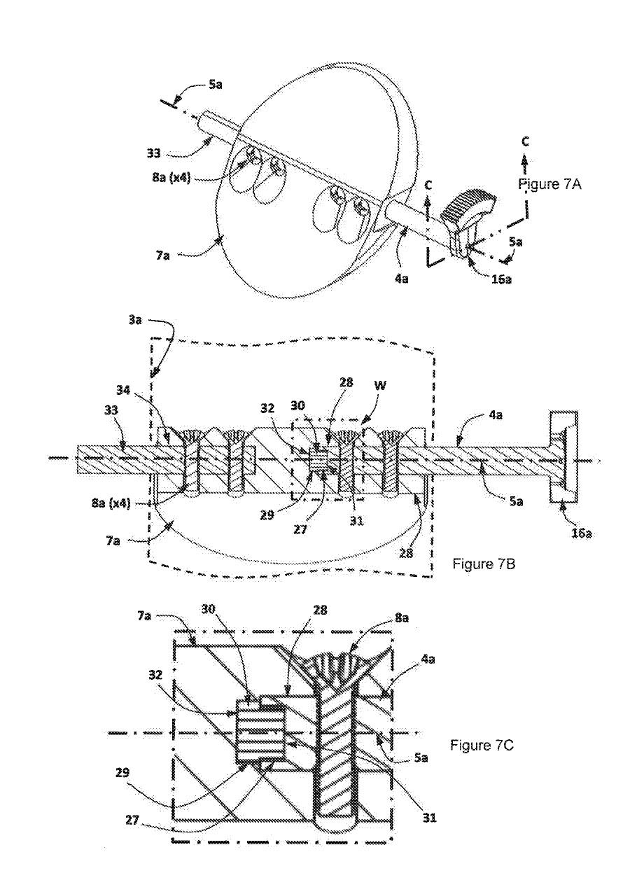

For illustration of the invention, only a partial assembly will be shown as other components of the throttle valve 1 may be unchanged. Similar components will be labeled with a similar number followed by a lowercase letter. FIG. 6A shows an exploded view of a partial assembly comprising a drive gear 16a, a first valve shaft 4a, a second valve shaft 33, fasteners 8a, and valve plate 7a. Additional detailed views may also be seen in FIGS. 6B-6D and in FIG. 7A-7C. The length of the valve shaft 4a that extends within the bore 3a has been reduced. For reference and for the purpose of illustration, the bore 3a has been represented as dashed lines in FIG. 7A. For this embodiment the length of shaft 4a is approximately one half the diameter of bore 3a although another length may be used such as three quarters of the diameter of bore 3a or another fractional length that is less than the diameter of the bore 3a. A first cavity 27, having a first shaped cross-section, may extend into a portion of valve shaft 4a along its central longitudinal axis 5a. For example, the first cavity 27 may extend 5 mm, 10 mm, or another suitable dimension into the valve shaft 4a. The valve plate 7a may have an opening 28 extending into the valve plate 7a for receiving the valve shaft 4a. The opening 28 may also share the central longitudinal axis 5a of the valve shaft 4a. A second cavity 29, having a second shaped cross-section, may extend from the opening 28 further into the valve plate 7a. The second cavity 29 may extend 5 mm, 10 mm, or another suitable dimension into the valve plate 7a. A coupling device 30 may have a first end 31 having a first shaped cross-section for engagement with the first cavity 27 of the valve shaft 4a and; a second end 32 having a second shaped cross-section for engagement with the second cavity 29 of the valve plate 7a. Fasteners 8a may be used to fasten the valve shaft 4a to valve plate 7a. The addition of the coupling device 30 will provide an increased strength to the connection between the valve shaft 4a and valve plate 7a as the shearing force is now distributed to both fasteners 8a and coupling device 30. Said differently, distribution of the shearing force reduces the torque moment on the fasteners 8a, and, therefore, reduces the amount of shearing force on the fasteners 8a.

Assembling the coupling device 30, valve shaft 4a, and valve plate 7a may be difficult because there can be no clearance or movement between the coupling device 30, the valve shaft 4a and the valve 7a in order to translate the rotatable force from the valve shaft 4a to the valve plate 7a. A slide fit of the coupling device 30 into the first and second cavities 27, 29 could be used but it would require a clearance and any movement between the coupling device 30, the valve shaft 4a and valve plate 7a would result in the shearing force being applied to only fasteners 8a. Press fits may be used but one or two press fits may not be desirable for the assembly process. It is an objective of the present invention to allow for assembly while providing the additional strength at higher operating temperatures by effectively utilizing another material property, the coefficient of thermal expansion.

The coefficient of thermal expansion (CTE) is the amount a material will expand or contract due to a change in temperature and is generally considered to be the degree of expansion divided by the change in temperature. Most materials expand with higher temperature but the amount of expansion may differ with different materials. For example, the material of the valve shaft 4a may have a first CTE that is 10×10−6 meters/meter per° C., the material of the valve plate 7a may have a second CTE that is 10×10−6 meters/meter per° C., and the material of the coupling device 30 may have a third CTE of 18.5×10−6 meters/meter per° C. When the temperature of these components is increased from 20° C. to 700° C., a 10.0 mm dimension for the materials of the valve shaft 4a and valve plate 7a will increase to 10.068 mm and; a 10.0 mm dimension for the material of the coupling device 30 will increase to 10.126 mm. The dimension of the coupling device 30 has increased 0.058 mm more than the valve shaft 4a and the valve plate 7a. This difference in the dimension at the higher temperature may permit a design of a coupling device 30 wherein at a lower operating temperature there will be a clearance that will allow for assembly of the coupling device 30 into the first and second cavities 27, 29 of the valve shaft 4a and valve plate 7a, and; wherein at a higher operating temperature there will be an interference and no clearance between the coupling device 30 within the first and second cavity 27, 29 of the valve shaft 4a and valve plate 7a.

For the example above, at a first operating temperature of 20° C., the first and second cavities 27, 29 of the valve shaft 4a, and valve plate 7a may have a dimension of 10.00 millimeters (mm) and; the first and second ends 31, 32, of the coupling device 30, may have a mating dimension of 9.980 mm. The smaller dimension of the first and second ends 31, 32, of the coupling device 30, may allow for a slide fit into the first and second cavities 27, 29 of the valve shaft 4a and the valve plate 7a. At a second operating temperature of 700° C., the 10.00 mm dimension of the first and second cavities 27, 29 may increase to 10.068 mm and; the 9.980 mm dimension of the coupling device 30 may increase to 10.105 mm. There is now an interference fit between the coupling device 30 and the first and second cavities 27, 29 of the valve shaft 4a and valve plate 7a. The interference will occur because the CTEs of the materials used for the coupling device 30, valve shaft 4a, and valve plate 7a will cause a dimensional change of the first and second ends 31, 32, of the coupling device 30, that exceeds the dimensional change of the cavities 27, 29 in valve shaft 4a and valve plate 7a.

The coupling device 30 may function in a valve arrangement in the following manner. At a first lower operating temperature, and when the valve shaft 4a is being rotated by a rotatable force, the coupling device 30 has clearance within at least one of the first or second cavities 27, 29 and; the coupling device 30 does not translate the rotatable force to the valve plate 7a and does not bear a shearing stress, and; at a second higher operating temperature, at least one of; the first CTE of the shaft 4a, the second CTE of the valve plate 7a, or the third CTE of the coupling device 30a, will result in a dimensional change and the coupling device 30 may not have clearance within the first and second cavities 27, 29, and; the coupling device 30 translates the rotatable force to the valve plate 7a and bears a shearing stress.

The first operating temperature may be near room temperature such as 20° C. and the second operating temperature may be an elevated temperature such as 500° C., 600° C., 700° C. or other elevated temperature. The temperature at which the interference will occur is dependent upon the initial dimensions of the components and CTEs of the materials used for the components.

For the exemplary embodiment, the shaped cross-section of the first and second cavities 27, 29 of valve shaft 4a and valve plate 7a, and; the first and second ends 31, 32 of coupling device 30, was a substantially triangular shape that provided engagement between the first and second ends 31, 32, of the coupling device 30, and; the first and second cavities 27, 29 of valve shaft 4a and valve plate 7a. It is also within the scope of the invention to use another shape or combination of shapes that may include a square shape, a rectangle shape, an oval shape, a circular shape, a spline shape or other suitable shape. It may be noted that dimensions for the first and second ends 31, 32 of coupling device 30 may have different dimensions. For example, first end 31 may have a smaller dimension than second end 32. The dimensions may be adjusted to fit the available space to make engagement with the first and second cavities 27, 29 of the valve shaft 4a and valve plate 7a.

The exemplary embodiment of FIGS. 6A and 7A also show a second valve shaft 33 that may be attached to the valve plate 7a by fasteners 8a. Second valve shaft 33 may be received within a second opening 34 within the valve plate 7a. The second valve shaft 33 and second opening 34 within the valve plate 7a may share the central longitudinal axis 5a of valve shaft 4a. Second valve shaft 33 may complement valve shaft 4a in providing for rotation of the valve plate 7a, however, it is also within the scope of the invention to only have one valve shaft 4a and have the benefits of the present invention described herein.

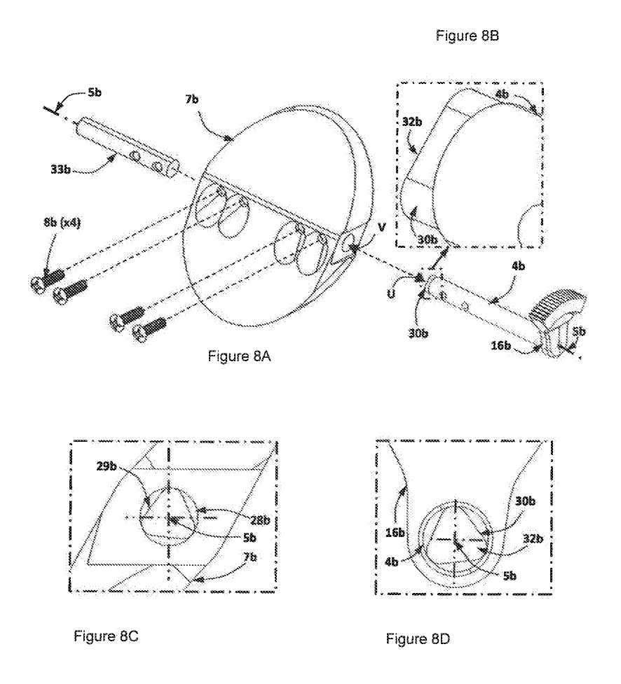

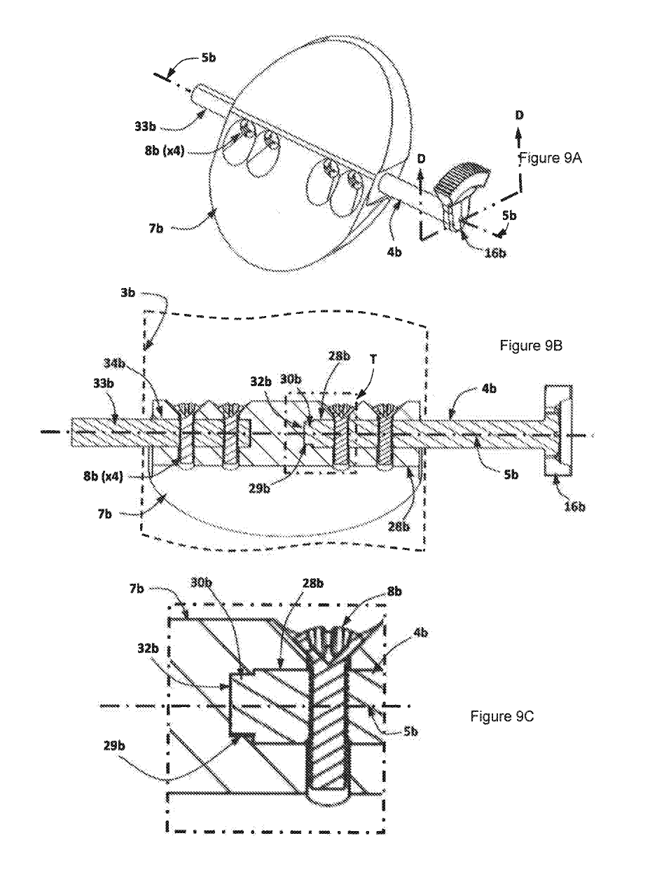

The exemplary embodiment has shown the coupling device 30 as a separate component. It is also within the scope of the invention to integrate the coupling device in one of the valve components. For example, it may be integrated on an end of the valve shaft as disclosed in a second embodiment of the invention shown in FIG. 8A. Again, for illustration of the invention, only a partial assembly will be shown as other components of the throttle valve 1 may be unchanged and; similar components will be labeled with a similar number followed by a lowercase letter. FIG. 8A shows an exploded view of a partial assembly comprising a drive gear 16b, a first valve shaft 4b, a second valve shaft 33b, fasteners 8b, and valve plate 7b. Additional detailed views may also be seen in FIGS. 8B-8D and in FIGS. 9A and 9B. The length of the valve shaft 4b that extends within the bore 3b has also been reduced to a similar length of valve shaft 4a. For reference and for the purpose of illustration, the bore 3b has be represented as dashed lines in FIG. 9A. Shaft 4b has been reduced in length to approximately one half the diameter of bore 3a although another length may be used such as three quarters of the diameter of bore 3a or another fractional length that is less than the diameter of the bore 3b.

A coupling device 30b may be formed on an end 32b, of valve shaft 4b. Coupling device 30b may have a first shaped cross-section that may extend for a length along the central longitudinal axis 5b of valve shaft 4b. For example, the first shaped cross-section, of coupling device 30b, may extend 5 mm, 10 mm, or another suitable dimension along the valve shaft 4b. The valve plate 7b may have an opening 28b extending into the valve plate 7b for receiving the valve shaft 4b. The opening 28b may also share the central longitudinal axis 5b of the valve shaft 4b. A cavity 29b, having a second shaped cross-section, may extend from the opening 28b further into the valve plate 7b. The cavity may extend 5 mm, 10 mm, or another suitable dimension into the valve plate 7b. The first shaped cross-section, on end 32b, of coupling device 30b, may engage the second shape cross-section of cavity 29b, in valve plate 7b, as the valve shaft 4b is received in opening 28b of valve plate 7b. Fasteners 8b may be used to fasten the valve plate 7b to the valve shaft 4b. The addition of the coupling device 30b will provide an increased strength to the connection between the valve shaft 4b and valve plate 7b as the shearing force is now distributed to both fasteners 8a and coupling device 30b.

The coupling device 30b will function in a similar manner as previously described for coupling device 30. At a first lower operating temperature, and when the valve shaft 4b is being rotated by a rotatable force, the coupling device 30b has clearance within cavity 29b and; the coupling device 30b does not translate the rotatable force to the valve plate 7b and does not bear a shearing stress, and; at a second higher operating temperature, at least one of; the first CTE of the coupling device 30b or the second CTE of the valve plate 7b, will result in a dimensional change and the coupling device 30b may not have clearance within the cavity 29b, and; the coupling device 30b translates the rotatable force to the valve plate 7b and bears a shearing stress.

A second valve shaft 33b may be attached to the valve plate 7b by fasteners 8b. Second valve shaft 33b may be received within a second opening 34b within the valve plate 7b. As previously stated, the second valve shaft 33b may complement valve shaft 4b in providing for rotation of the valve plate 7b, however, it is also within the scope of the invention to only have one valve shaft 4b and have the benefits of the present invention described herein.

As shown herein, the valve 1 comprises the first valve shaft 4a, 4b and the second valve shaft 33, 33b. One having skill in the art will appreciate that the valve 1 may comprise a single valve shaft or any number of valve shafts. Furthermore, one having skill in the art will appreciate that the first valve shaft 4a, 4b and the second valve shaft 33, 33b, and the coupling device 30, 30b, may be used with any valve plate 7. Said differently, the first valve shaft 4a, 4b and the second valve shaft 33, 33b, and the coupling device 30, 30b, may be used with various valve plates 7 (i.e., valve plates 7 of any size, shape, and configuration), without escaping the scope of the subject invention.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A coupling device for a valve arrangement comprising;
a valve comprising;
a valve housing including a bore for receiving and delivering a fluid,
a rotatable valve shaft, for receiving and translating a rotatable force, the valve shaft being supported in the valve housing and having a central longitudinal axis and; a first cavity, having a first shaped cross-section, extending into a portion of the valve shaft along the central longitudinal axis and; having a first coefficient of thermal expansion (CTE),
a valve plate, having a second CTE, located within the bore of the valve housing, the valve plate being rotatable, between a valve open and valve closed position, by the rotatable force translated by the valve shaft; the valve plate further comprising;
an opening extending into the valve plate for receiving the valve shaft, the opening also sharing the central longitudinal axis of the valve shaft,
a second cavity, having a second shaped cross-section, extending from the opening further into the valve plate and,
a coupling device, having a third CTE, and; a first end having a first shaped cross-section, for engagement with the first cavity of the valve shaft and; a second end having a second shaped cross-section for engagement with the second cavity of the valve plate; and,
wherein, at a first operating temperature the coupling device will have a clearance within at least one of the first or second cavities and;
wherein at a second operating temperature, and wherein the valve shaft is being rotated by a rotatable force, at least one of; the first CTE of the valve shaft, the second CTE of the valve plate, or the third CTE of the coupling device, will result in a dimensional change and the coupling device does not have clearance within the first or second cavities, and; wherein the coupling device translates the rotatable force to the valve plate, and bears a shearing force and;
wherein the first operating temperature is lower than the second operating temperature.

2. The coupling device for a valve arrangement of claim 1 wherein; the first and second shaped cross-section on the first end, the second end, or both the first and second end of coupling device may be a triangular shape, a square shape, rectangular shape, an oval shape, a circular shape, or a spline shape, and; wherein the first shaped cross-section of the first cavity, extending into the valve shaft, and the second shaped cross-section of the second cavity, extending into the valve plate, may be a triangular shape, a square shape, a rectangular shape, an oval shape, a circular shape, or a spline shape.

3. The coupling device for a valve arrangement of claim 1 further comprising a fastener for fastening the valve plate to the valve shaft and:
wherein when the valve shaft is being rotated by a rotatable force, the fastener translates the rotatable force to the valve plate, and bears a shearing force and:
wherein, at the first operating temperature only the fastener may translate the rotatable force and bear the shearing force and; at the second operating temperature both the fastener and the coupling device may translate the rotatable force and bear a shearing force.

4. The coupling device for a valve arrangement of claim 3 wherein the fastener may be a screw, a rivet, a pin, or a welded connection.

5. The coupling device for a valve arrangement of claim 1 wherein, the valve shaft extends into the valve plate by a length that is; one half the diameter of the valve bore, three quarters the diameter of the valve bore, or a fractional amount that is less than the diameter of the valve bore.

6. A coupling device for a valve arrangement comprising;
a valve comprising;
a valve housing including a bore for receiving and delivering a fluid,
a rotatable valve shaft, for receiving and translating a rotatable force, the valve shaft being supported in the valve housing and having a central longitudinal axis and; an end, having a first shaped cross-section, extending from the end of the valve shaft along the central longitudinal axis and; having a first coefficient of thermal expansion (CTE),
a valve plate, having a second CTE, located within the bore of the valve housing, the valve plate being rotatable, between a valve open and valve closed position, by the rotatable force translated by the valve shaft; the valve plate further comprising;
an opening extending into the valve plate for receiving the valve shaft, the opening also sharing the central longitudinal axis of the valve shaft
a cavity, having a second shaped cross-section, extending from the opening further into the valve plate and,
wherein, the end of the valve shaft, having the first shaped cross-section, is inserted into the opening of the valve plate and; the first shaped cross-section, of the end of the valve shaft, engages the second shaped cross-section of the cavity of the valve plate, and;
wherein, at a first operating temperature there is a clearance within the cavity of the valve plate and the first shaped cross-section on the end of the valve shaft and;
wherein at a second operating temperature, and wherein the valve shaft is being rotated by a rotatable force, at least one of the first CTE of the valve shaft or the second CTE of the valve plate will result in a dimensional change and; there is no clearance within the cavity, of the valve plate, and the first shaped cross-section, on the end of the valve shaft, and; wherein the end of the valve shaft with the first shaped cross-section translates the rotatable force to the valve plate, and bears a shearing force and;
wherein the first operating temperature is lower than the second operating temperature.

7. The coupling device for a valve arrangement of claim 6 wherein; the first shaped cross-section on the end of the valve shaft may be a triangular shape, a square shape, rectangular shape, an oval shape, a circular shape, or a spline shape, and; wherein the second shaped cross-section of the cavity extending into the valve plate may be a triangular shape, a square shape, a rectangular shape, an oval shape, a circular shape, or a spline shape.

8. The coupling device for a valve arrangement of claim 6 further comprising a fastener for fastening the valve plate to the valve shaft and:
wherein when the valve shaft is being rotated by a rotatable force, the fastener translates the rotatable force to the valve plate, and bears a shearing force and:
wherein, at the first operating temperature only the fastener may translate the rotatable force and bear the shearing force and; at the second operating temperature both the fastener and the shaped cross-section on the end of the valve shaft may translate the rotatable force and bear a shearing force.

9. The coupling device for a valve arrangement of claim 8 wherein the fastener may be a screw, a rivet, a pin, or a welded connection.

10. The coupling device for a valve arrangement of claim 6 wherein, the valve shaft extends into the valve plate by a length that is; one half the diameter of the valve bore, three quarters the diameter of the valve bore, or a fractional amount that is less than the diameter of the valve bore.
